(19) United States
(12) Patent Application Publication
(10) Pub. No.: US 2012/0111646 A1
(43) Pub. Date: May 10, 2012

(54) DRAFT SHIELD FOR A BALANCE

(75) Inventor: Alfred Schillig, Gruningen (CH)

(73) Assignee: METTLER-TOLEDO AG, Greifensee (CH)

(21) Appl. No.: 13/285,032

(22) Filed: Oct. 31, 2011

(30) Foreign Application Priority Data
Nov. 4, 2010 (DE) 102010050225.1

(51) Int. Cl. G01G 21/28; B23P 19/00

(52) U.S. Cl. 177/181; 177/180; 29/700

(57) ABSTRACT

A draft shield (31) for a balance (32) has a box-like frame that encases the balance and a housing (40, 40a, 40b) thereof. The draft shield stands by itself on the same work surface (33) as the balance, leaving clear space on at least the sides of the housing. Front and rear walls of the draft shield have bottom edges arranged above the work surface, so that a display- and operating part (42) of the balance protrudes to the outside below the front wall and that the rear part of the housing remains accessible. Side walls and a ceiling wall allow at least portions thereof to be individually opened. A centering and bottom-closure part (43) is adapted to be seated or fastened on a top surface (41a) of the housing, with an outside border contour (45) that matches an inside contour of the box-like frame.

### CROSS-REFERENCE TO RELATED APPLICATIONS

This application is entitled to benefit of a right of priority under 35 USC §119 from German patent application DE 10 2010 050225.1, which was filed on 4 Nov. 2010, and the content of which is incorporated by reference as if fully recited herein.

### TECHNICAL FIELD

The disclosed embodiments concern a draft protection device for a balance, commonly called a draft shield, in particular for those types of balances which in their standard model version are typically not equipped with a draft shield. Accordingly, the disclosed embodiments relate to a kind of draft shield which can also be purchased and installed later by the customer as an accessory to a balance.

### BACKGROUND

Draft shields in balances of high accuracy which, accordingly, are also very sensitive, have the purpose to prevent that the weighing result is adversely affected by the movements of the ambient air. Such air drafts, which can be caused for example by air-conditioning systems or by open doors and windows, can exert steady or fluctuating forces on the weighing pan which will manifest themselves to the user of the balance as errors, fluctuations and irregularities of the displayed weighing result. Draft shields frequently come in the form of an enclosure case that is arranged on the scale housing and surrounds the weighing pan, with a bottom, side walls and a top cover, and the space enclosed by the draft shield is referred to as the weighing compartment. A passage opening, normally in the bottom of the weighing compartment, provides contact-free clearance for the passage of a load transfer element, which connects the weighing pan that is located in the weighing compartment to a weighing cell that is arranged in the balance housing. The side walls and/or the top cover of the draft shield are normally designed so that they can be opened and closed in order to allow the weighing object to be put on, and removed from, the weighing pan that is located inside the weighing compartment.

Draft shield devices of the kind mentioned in the introductory paragraph, which are not part of the standard model version of a balance but can be purchased and installed later if they are needed, often turn out to be desirable or useful in precision balances with a display resolution of 0.01 grams or even 0.1 grams, if the balances are exposed to stronger air movements during operation, which lead to fluctuations, uncertainties and errors of the displayed weighing result. In balances of higher resolution, i.e. displaying the weighing result with three or more decimals, this problem is found already in a relatively undisturbed ambient atmosphere. This is the reason why such balances normally have a draft shield in their standard model version. Balances with a coarser resolution, on the other hand, where the result is indicated in steps of one, two, five, ten or more grams, are normally insensitive to air movements, so that there is no need for any draft shield, whether installed as standard equipment or available for purchase as an accessory.

In the following examples of the existing state of the art as well as in the description of the draft shield, expressions such as “on top”, “at the bottom”, “in front”, “to the rear”, “left” and “right” are always meant in reference to a draft shield that is installed and ready for operation, in its normal working position as seen from the direction of the user.

A draft shield that can be set on top of a balance and attached to as well as removed from the latter in a simple way without tools is described for example in US 2009/194340 A1. This draft shield is designed in the shape of a cabinet with sliding doors on the sides as well as a sliding top cover panel, a front wall, a rear wall, and a floor, wherein the footprint dimensions, i.e. the length and width of the floor panel, correspond approximately to the horizontal top surface of the balance housing, so that in the installed state of the draft shield the side doors are aligned flush with the lateral wall surfaces of the balance housing. The draft shield is releasably connected to the balance housing through an arrangement where the draft shield can be fastened at its center to the passage opening for the load transfer element in the top surface of the balance housing, wherein for example the rim of the passage opening on the topside of the balance housing is configured as a first part of a bayonet coupling which cooperates with a second bayonet coupling part that is arranged at the passage opening of the floor of the draft shield. Besides, this draft shield device is intended as a standard part of an analytical balance (i.e. a balance with three or more display decimals) that is designed to be connected to the draft shield.

If one considers the possibility of using this draft shield device for the purpose mentioned in the introductory paragraph, i.e. as an accessory to a balance which in its standard model version is not normally equipped with a draft shield, one encounters several problems. First of all, this draft shield device could only be used for those balances which come equipped with the requisite bayonet coupling as a standard feature. This would on the one hand add to the cost of the standard model version, while it would on the other hand strongly limit the draft shield in regard to the balance models for which it could be used. Given that the objects which are weighed on precision balances with one or two display decimals are generally larger than the objects weighed on analytical balances, the draft shield device would likewise need to be designed commensurately larger, and since this draft shield is delivered from the factory already in fully assembled condition, it would require a voluminous and therefore expensive shipping package for the delivery to the customer. Also of concern is the fact that, in their opened position, the sliding doors will protrude rearwards out of the draft shield, which would take up additional work space behind the balance.

A simple and more compact design of a draft shield device is presented in U.S. Pat. No. 5,583,322, which is designed specifically for precision balances, i.e. the category of balances with typically one or two display decimals. This draft shield, which has the form of a box with a flip-up lid, is set onto the top surface of the balance housing and secured in its position by the mutual engagement of projections in the balance housing and matching recesses in the bottom of the draft shield device. The weighing pan is accessible only from above by raising the flip-up lid, which can be held open in an inclined position by a tensioning spring in the hinge of the lid. The non-movable walls of this draft shield device can only have a limited height, so as not to interfere too much with the loading and unloading of the weighing pan from above. However, this severely limits the height for a practical design, so that this draft shield device would not be suitable for the weighing of taller objects, such a glass beakers and Erlenmeyer flasks. The use of this draft shield is further limited to balances which include the aforementioned projections that are required to hold the draft shield in place. This draft shield, too, leaves the factory fully assembled and therefore requires a relatively expensive shipping package.

A further example of a draft shield device that is intended as an accessory for a balance whose standard model version is not equipped with a draft shield is presented in U.S. Pat. No. 4,893,686. In a first embodiment, this device has essentially the form of a round chimney which concentrically surrounds a circular weighing pan, with at least two sections that can be pulled out of each other or pushed into each other like a telescope, which allows the height of the draft shield device to be adapted to the height of the weighing object. To hold it in a defined position, this draft shield is set into a ring which is solidly connected to the top surface of the balance housing and concentrically surrounds the weighing pan. This draft shield can be closed off from above by putting a lid on it. In a second embodiment of this draft shield concept, the cross-sectional profile of the telescopically extendable chimney is rectangular and dimensioned large enough that it can be set over the entire balance and rest directly on the same table surface on which the balance is standing. The front part of the balance which faces towards the user and carries the display and the operating keys protrudes through a frontal cutout in the bottom part of the chimney and is thus freely accessible.

This concept likewise raises several concerns. Particularly for so-called weighing-in processes, where a container standing on the weighing pan is filled with a substance until a prescribed target weight has been reached, the weighing compartment needs to remain accessible during the entire filling process but should at the same time offer the desired protection against air drafts, including from above if necessary, a condition that cannot be met with an unattached removable lid and without access from the side. With the rectangular shape of the draft shield that is set directly on the table surface on which the balance is standing, it is also possible for air drafts to enter through the frontal cutout for the operating controls of the balance. Also, the cited reference provides no information as to how the draft shield device that rests on the table surface can be held in a defined position relative to the balance.

Other draft shields that are set directly onto the same work surface on which the balance itself is standing have been built by the applicant as special made-to-order units to meet requests from customers. A solution that suggests itself consists of a box without a bottom, which is set over the balance onto the same work surface on which the balance itself is standing. The walls and top of this draft shield consist of transparent glass- or plastic plates that are held together by a metal frame. The side wall panels and the top cover panel run in track grooves of the frame, so that they can be pushed to the rear, whereby the weighing pan is made accessible from the side as well as from above. The front wall does not extend over the entire front of the draft shield but leaves a certain distance between its bottom border and the work surface, so that the lower portion of the draft shield has a passage opening through which the display- and operating part of the balance sticks out at the front. The draft shield is designed with sufficiently large dimensions, so that it can be used for all of the types of balances for which a draft shield might be needed and also for objects that overhang the balance pan sideways as well as for tall weighing containers. Negative aspects of this solution are that there needs to be enough free space to the rear of the draft shield to allow the side wall- and top cover panels to be opened, further that air drafts can enter through the large opening at the front and act on the weighing pan directly from below, and also that the draft shield cannot be secured in its position relative to the balance.

A further draft shield device which was built as a custom design and is already in use—and therefore belongs to the state of the art—follows the same basic design concept of a box without a bottom panel which is set over the balance onto the same work surface on which the balance itself is standing. The side walls of this draft shield have cutouts whose shape conforms to lateral projections of the balance housing, whereby the draft shield device is centered in its position relative to the balance housing. However, this concept requires the draft shield to be tailored exactly to the housing contours of a specific balance type, whereby the range of uses for this draft shield device is limited to the respective balance type. Furthermore, this draft shield, likewise, is not completely impenetrable to air drafts which can enter through the opening at the front and exert a force on the balance pan directly from below.

The experience gained from using these draft shields has also shown that sliding doors and sliding top cover panels are in almost all cases not only unnecessary but actually undesirable. In particular for the “weighing-in” process that was mentioned above, i.e. when filling a substance into a container that is standing on the balance until a given target weight has been reached, either a side wall or the top cover necessarily has to stay open during the entire filling process if the substance is dispensed manually into the container. On the other hand, a large enough space to the rear of the draft shield needs to kept free at all times for the sole purpose of allowing the sliding doors and the sliding cover to be opened.

It is therefore the object herein to create a draft shield device which is designed as an accessory for balances whose standard model version does not include a draft shield, and which meets the requirements that are relevant to this kind of draft shield to a significantly higher extent than the draft shields of the known state of the art. These requirements include in particular that:

the draft shield should have a shape and dimensions that allow for flexibility of use with different types of balances;

the draft shield should have the capability to be centered relative to the balance and locked in place, without the need to equip the standard model version of the balance with additional fastening- and centering means;

that the weighing compartment is closed at the bottom, so that the weighing pan is protected against air drafts from below;

that the draft shield can be opened on the sides and, if necessary, also at the front or on top, without the need to provide additional free space for this purpose, as would be necessary for example to allow sliding doors to be opened; and

that the draft shield can be made at low cost, delivered in a compact package, and assembled by the user and put into operation without problems.

### SUMMARY

These objectives are solved by a draft shield for a balance, wherein the draft shield has a front wall, a rear wall, two side walls, and a ceiling wall. Together, these walls form a box which is open at the bottom and, in its installed state, encases the balance and encloses a weighing compartment containing a weighing pan that is arranged above a top surface of a balance housing. The draft shield device stands by itself on the same work surface as the balance housing, leaving clear space at least on the sides of the balance housing. The bottom edges of the front wall and the rear wall are arranged at a sufficient height above the work surface that the display- and operating part of the balance can protrude to the outside below the front wall and the rear part of the balance housing remains accessible for cable connections. The side walls and, if desired, the front- and rear walls, and the ceiling wall are designed to allow at least portions of these walls to be individually opened. Further, this draft shield device is centered and secured in its position relative to the balance and at the same time closed off at the bottom by a centering and bottom-closure part which can be seated or fastened on the top surface of the balance housing with a shape-conforming fit and which has an outside border contour that matches an inside contour of the draft shield device, so that the front wall, the rear wall and the side walls lie flush against the outside contour of the centering and bottom-closure part when the draft shield is in its installed position on the balance.

The centering and bottom-closure part is preferably formed of a piece of flat material, for example sheet metal, in which cutouts are arranged to provide a passage opening for the weighing pan carrier and, if necessary, a window opening for a spirit level which may be recessed in the top surface of the balance housing. Of course, the centering and bottom-closure part could also be made of a synthetic material.

Since the draft shield in its installed state closely fits the outside border contour of the centering and bottom-closure part, the position of the draft shield on the work surface in relation to the balance is immovably fixed, while the draft shield, due to the close fit between its internal contour and the contour shape of the centering and bottom-closure part, is at the same time closed off at the bottom, so that no air drafts can enter from below. As the lower part of the front is not closed off by the front wall, the display- and operating part of the balance can protrude out of the draft shield at the front, while a similar opening at the rear allows free access for cable connections. In addition, both openings improve the air circulation to carry away the heat generated by the electrical components of the balance. Due to the fact that the side walls of the draft shield have a certain distance from the balance housing, it is possible to use the device for balances with housings of different widths, as well as for balances with a weighing pan that fills the full width of the footprint profile of the balance housing, and also for bulky weighing objects that overhang the balance pan on the sides.

To allow a draft shield as disclosed herein and designed with given, fixed dimensions to be used for a variety of balance models of different dimensions and with different configurations of their housing top surfaces to which the centering and bottom-closure part is fastened, it is advantageous to produce the centering and bottom-closure part in different versions with appropriate centering- and fastening features matched to the respective balance model. Thus, it is possible to meet the demand for draft shields which, in any event, is not very high in proportion to the production volume for balances, with a single base model of the disclosed draft shield, wherein only the appropriate centering and bottom-closure part needed for the specific type of balance has to be included in the delivery.

In a practical embodiment, the draft shield is configured as a rigid, box-shaped frame wherein wall panels on the left and right side and, if required also at the front and rear, can be set into the frame from above, and easily removed again by pulling upwards, and wherein a ceiling panel can be laid into the frame from above or slid into the frame from the side and can likewise be easily removed again.

A storage compartment is conveniently arranged at the rear wall of the draft shield, where at least one removed side wall panel or the ceiling panel can be kept readily accessible.

With the side wall panels that are set in place from above and with the ceiling panel that can be lifted up or pulled out sideways, the problem of taking up additional space behind the balance is avoided, in contrast to draft shields with sliding doors and sliding covers that are pushed to the rear, where the need for the extra space is an inherent problem. Furthermore, as already mentioned, after the user of the balance has chosen his way of access to the draft shield either from the right or the left, or possibly from the front or from above, the respective wall panel will in any case stay open permanently, so that it is more practical to remove the panel and set it into the storage compartment which is included as part of the inventive concept.

In the interest of manufacturing economy, it is advantageous if the left and right side wall panels and/or the front and rear wall panels, as well as at least pairs of frame components are identical to each other in their respective designs.

In a particularly preferred embodiment, all wall panels as well as the ceiling panel are designed as five identical square plates which can be slid into appropriately arranged grooves in the rigid frame of the draft shield device.

For storage, packaging and shipping to customers, it is of advantage if the draft shield device is designed as a kit in which the side wall panels, the front and rear panels, the ceiling panel, the frame components and the centering and bottom-closure part are delivered to the user as a compact, flat package from which the draft shield can be easily assembled. The parts are preferably connected with screws, and the required small parts such as screws, nuts, washers and the like, as well as an appropriate tool, are included in the kit package.

### BRIEF DESCRIPTION OF THE DRAWINGS

The embodiments that incorporate and define the inventive concept will be explained hereinafter in more detail with examples of embodiments that are represented in the drawings, wherein identical parts are identified with identical part numbers and wherein:

FIG. 1 shows a first draft shield according to the known state of the art, which stands by itself on the same work surface as the balance;

FIG. 2 shows a second draft shield device according to the known state of the art, which stands on the same work surface as the balance and is held in position by form-fitting contact with lateral projections of the balance housing;

FIG. 3 shows a preferred embodiment of the draft shield;

FIGS. 3a and 3b show two examples of the centering and bottom-closure part for the draft shield of FIG. 3;

FIG. 4 illustrates the draft shield of FIG. 3 with its components taken apart, in an exploded view; and

FIGS. 4a and 4b show the draft shield device of FIG. 3 in two stages of the assembly process.

### DETAILED DESCRIPTION

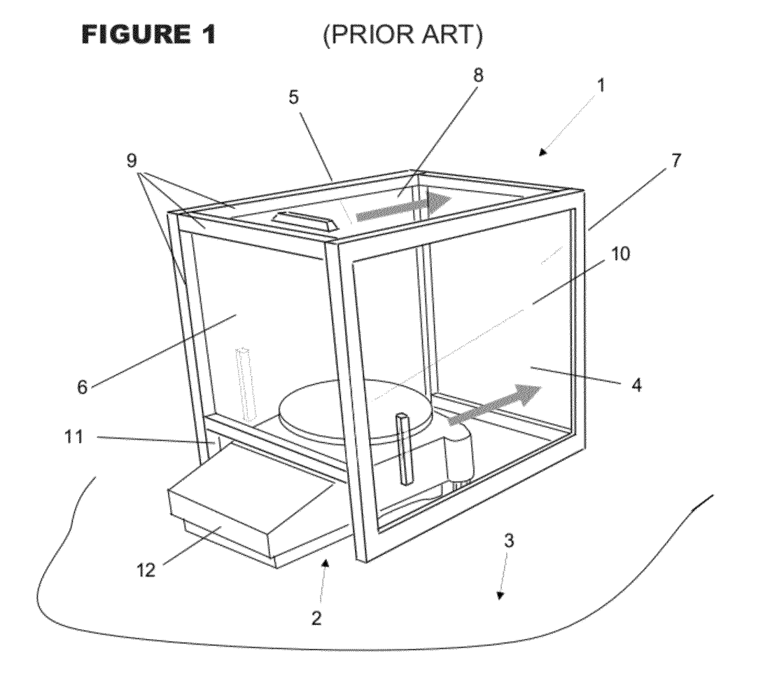

FIG. 1 shows a draft shield 1 according to the state of the art as described hereinabove. This solution, which presents itself as a natural choice, consists essentially of a box without a bottom, which is set over the balance 2 onto the same work surface 3 on which the balance itself is standing. The side walls 4, 5, the front wall 6, the rear wall 7 and the ceiling cover 8 of this draft shield consist of transparent glass- or plastic plates that are held together by a metal frame 9. The side wall panels 4, 5 and the ceiling panel 8 are sliding in track grooves of the frame 9, so that they can be pushed to the rear (as indicated by arrows in FIG. 1), whereby the weighing pan 10 is made accessible from the side as well as from above. The front wall 6 does not close off the entire front side of the draft shield 1, but starts only at some distance above the work surface 3, so that the draft shield has a passage opening 11 at the bottom, through which the display- and operating part 12 of the balance 2 sticks out to the front. The dimensions of the draft shield 1 are chosen sufficiently large that it can be used for practically any precision balance in the accuracy range of 0.01 grams to 0.1 grams as well as for the weighing of objects that overhang the balance or for tall weighing containers. This solution has the disadvantage that the sliding wall panels 4, 5 and 8 require a lot of free space to the rear of the draft shield 1, and that the large opening 11 at the front side exposes the balance pan 10 directly to air drafts from below, and also that the draft shield 1 cannot be secured in a centered position relative to the balance 2.

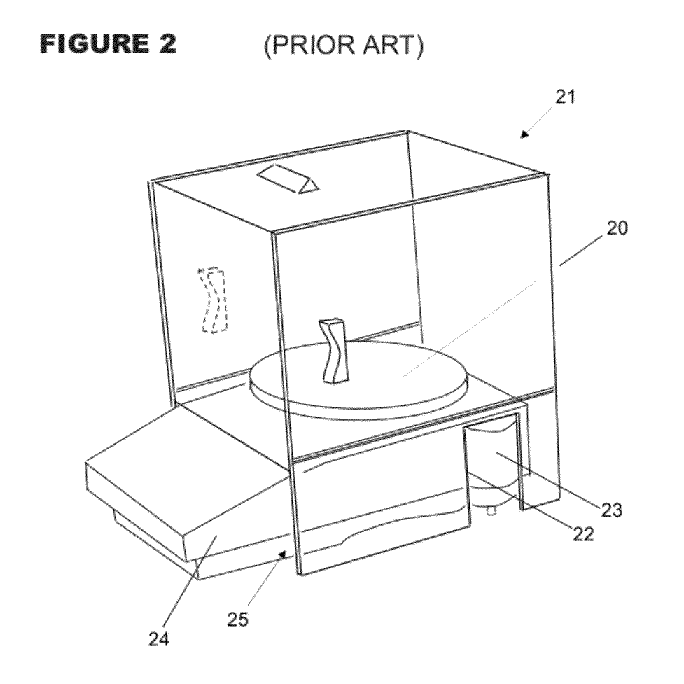

FIG. 2 shows a further draft shield 21, which was built and delivered as a special product and thus belongs to the state of the art. The draft shield 21 has shape-conforming cutouts 22 for lateral projections 23 of the balance housing 24, whereby the draft shield 21 is held in a fixed position relative to the balance housing 24. However, this concept requires the draft shield 21 to be tailored exactly to the housing contours of a specific balance type, whereby the range of uses for this draft shield device 21 is limited to balances of a given shape and size. Furthermore, this draft shield, likewise, is not completely impenetrable to air drafts which can enter through the opening 25 at the front and exert a force on the balance pan 20 directly from below.

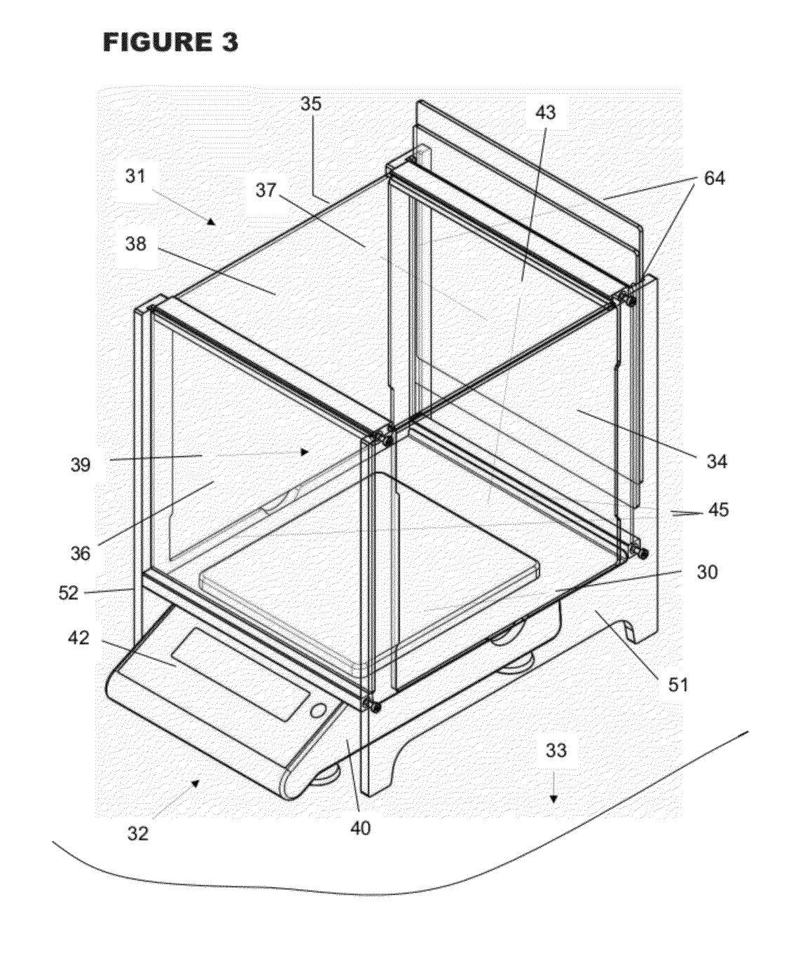

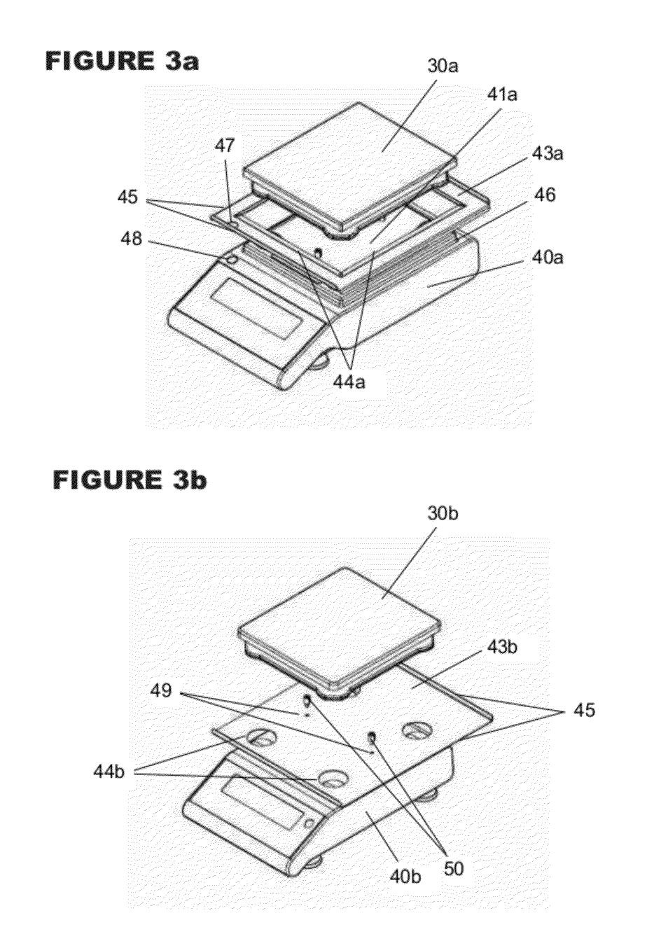

The draft shield 31 shown in FIG. 3 represents an example of a preferred embodiment of the invention. Analogous to the preceding examples in FIGS. 1 and 2, which illustrate the state of the art, the draft shield 31 likewise has the shape of a box that is open at the bottom and forms a cover over the balance 32, with a front wall 36, a rear wall 37, two side walls 34, 35, and a ceiling wall 38. Together, these walls enclose a weighing compartment 39 containing a weighing pan 30 that is arranged above a top surface (not visible in the drawing) of a balance housing 40. The draft shield 31 stands by itself on the same work surface 33 as the balance 32, leaving clear space at least on the sides of the balance housing 40. The bottom edges of the front wall 36 and the rear wall 37 are arranged at a sufficient height above the work surface 33 that the display- and operating part 42 of the balance 32 can protrude to the outside below the front wall 36 and that the rear wall of the balance housing 40 remains accessible for cable connections. The side walls 34, 35 and, if desired, the front- and rear walls 36, 37, and the ceiling wall 38 are designed to allow at least portions of these walls to be opened individually. Further, and in contrast to the examples of FIGS. 1 and 2, this draft shield 31 is centered and secured in its position relative to the balance 32, while the weighing compartment 39 is at the same time closed off at the bottom by a centering and bottom-closure part 43 which can be seated or fastened on the top surface (see details in FIGS. 3a and 3b) of the balance housing 40 with a shape-conforming fit and which has an outside border contour 45 that matches an inside contour of the draft shield 31, so that the draft shield 31 in its installed position directly adjoins the outside contour 45 of the bottom-closure part 43 on all sides.

Two examples 43a, 43b for the design of the centering and bottom-closure part are shown in detail in FIGS. 3a and 3b. The centering and bottom-closure part 43a in FIG. 3a has the shape of a rectangular frame which can be produced for example from sheet metal stock by die-punching and bending up the inside and outside borders. In addition, the centering and bottom closure part 43a has a window opening 47 at the front for a spirit level 48 located in the corresponding place of the balance housing 40a. After the weighing pan 30a has been taken off, the centering and bottom closure part 43a can be seated on a stepped-down ledge 46 of matching shape which runs along the perimeter of the top surface 41a of the balance housing 40a. Next, the weighing pan is set back on the balance, and the draft shield 31 is placed from above into the position that is defined by the centering and bottom closure part 43a.

The centering and bottom closure part 43b of FIG. 3b consists of a rectangular piece of sheet metal with four round openings for the posts that support the weighing pan 30b on a load receiver inside the balance housing 40b, and with two fastening holes 49. The centering and bottom closure part 43b can be attached to the top surface of the balance housing 40b, for example, with two fastening screws 50 which are already used to secure the balance housing 40b on a chassis base of the balance. The centering and bottom closure part 43b can be stiffened by bending up the front and rear borders (as shown in FIG. 3b) and/or the side borders.

The two examples shown in detail in FIGS. 3a and 3b illustrate a basic concept of the invention, according to which a single production model of the draft shield 31 can be used for a broad range of balance types by simply adding for each balance type the respective matching centering and bottom-closure part. The centering and bottom-closure parts 43a, 43b stand as representative examples for a basically unlimited range of variants, which can also be expanded as necessary when new balance models are introduced.

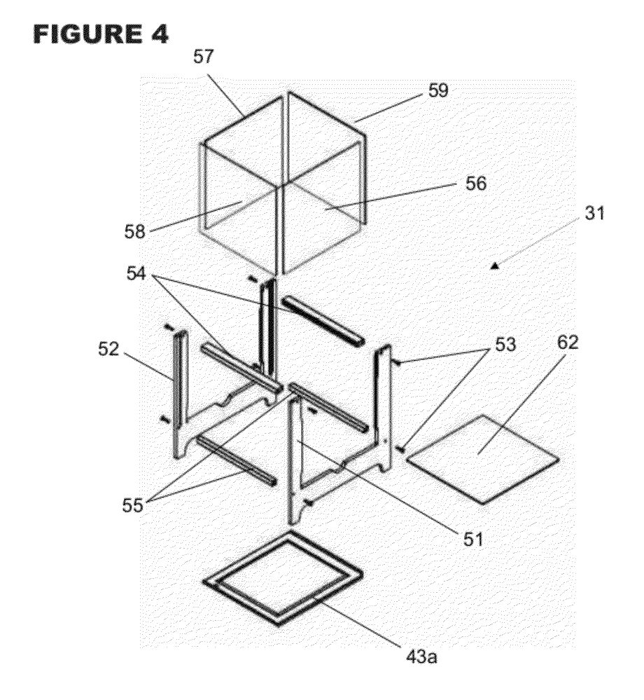

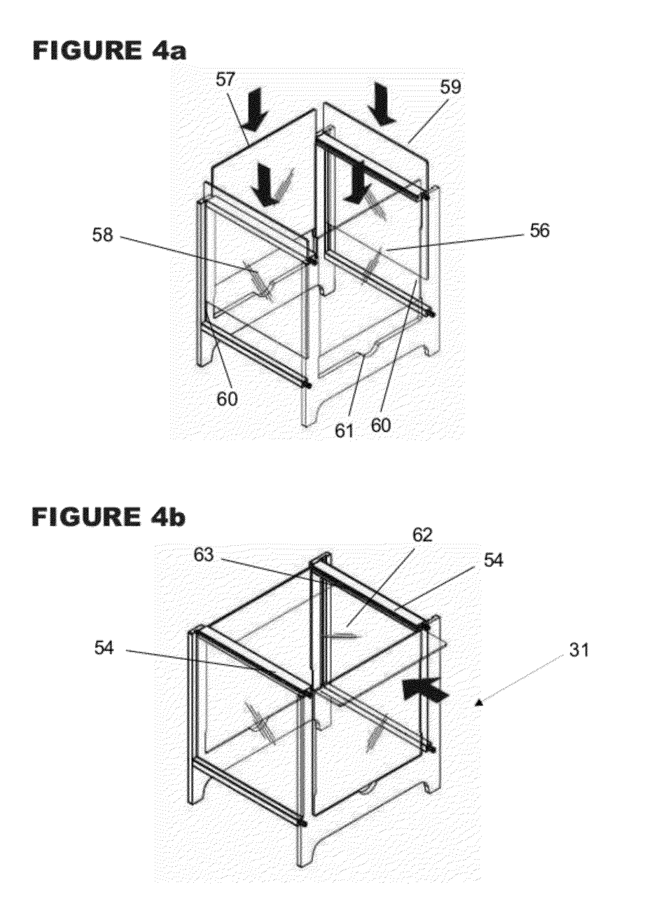

FIG. 4 shows the draft shield 31 of FIG. 3 in an exploded view looking at an angle from above at the right-hand upper front corner. This drawing illustrates how the draft shield 31 is designed in the form of a kit whose individual components can be packaged lying flat on top of each other. In the assembly process, the right and left frame parts 51, 52 are first attached to the upper and lower transverse members 54, 55, using a total of eight screws 53, whereby a rigid frame is formed.

Next, as shown in FIG. 4a, the side wall panels 56, 57, the front wall panel 58, and the rear wall panel 59 are inserted from above into appropriately arranged grooves 60 of the frame parts 51, 52 and slid all the way down into their rest positions on the horizontal sections of the H-shaped frame parts 51, 52 and on the lower transverse members 55. The frame parts 51, 52 have finger openings 61 so that the side wall panels 56 57 can easily be taken out again.

Finally, as shown in FIG. 4b, the ceiling panel 62 is slid from one side of the draft shield 31 into the grooves 63 of the upper transverse members 54. With the weighing pan 30a removed and as shown in FIG. 3a, the centering and bottom-closure part 43a, is set on a stepped-down ledge 46 which runs along the perimeter of the top surface 41a of the balance housing 40a, and the draft shield 31 is placed from above into the position that is defined by the centering and bottom closure part 43a.

During normal use of a balance 32 with a draft shield 31, at least one of the side wall panels 56, 57, and/or the ceiling panel 62, is taken out and kept in the storage compartment behind the rear wall panel 59 (see FIG. 3) which is formed by the lower transverse panel 55 and the additional grooves 64 in the frame parts 51, 52. FIG. 3 shows two wall panels held in the storage compartment which, for illustration purposes, are shown in a partially pulled-up position.

So that the side wall panels 56, 57 as well as the ceiling panel 62 fit into the storage compartment that is formed by the lower transverse member 55 and the additional grooves 64 in the frame parts 51, 52, at least the height of the side wall panels 56, 57 has to agree with the width of the ceiling panel 62. However, in the interest of economy and simplicity in the manufacture of the device, it is advantageous if the wall panels 56, 57, 58, 59 and the ceiling panel 62 are designed as five identical square plates.

Although the invention has been described through the presentation of a specific embodiment, it is evident that numerous further variants could be created based on the teachings of the present invention, wherein a draft shield that stands by itself and apart from the balance housing on the same work surface on which the balance itself is resting is secured in its position relative to the balance by means of a centering and bottom-closure part. Among other possibilities, embodiments of the invention come to mind where, for example, the frame of the draft shield is composed of four vertical corner posts and eight horizontal connecting members that can be rigidly attached to each other by screws or other suitable means. Also conceivable are further variants of removable wall and ceiling panels.

What is claimed is:

1. A draft shield for a balance having a weighing pan that is arranged above a top surface of a balance housing when the balance stands in operation upon a work surface, the balance also having a display- and operating part, the draft shield comprising:
a front and a rear wall;
a first and a second side wall;
a ceiling wall; and
a centering and bottom closure part;
the respective walls co-acting to form a box that stands independently on the work surface, leaves a clear space at least on the sides of the balance housing, and, in its installed state, encases the balance and defines a weighing compartment thereof;
the respective front and rear walls each having a bottom edge that is arranged, in operation, at a sufficient height above the work surface for the display- and operating part to protrude outside the box below the front wall and for a rear part of the balance housing to remain accessible for cable connections;
at least one of the side-walls and the ceiling wall designed to allow at least a portion thereof to be individually opened;
the centering and bottom closure part centering and securing the box in position relative to the balance while at the same time closing off the weighing compartment, the centering and bottom-closure part adapted to be seated or fastened on the top surface with a shape-conforming fit;
the centering and bottom closure part having an outside border contour that matches an inside contour of the box, so that, in operative installation, the front, rear and side walls will closely fit the outside border contour.

2. The draft shield of claim 1, wherein:
a piece of flat material forms the centering and bottom closure part, with cutouts in the piece of flat material arranged to provide passage openings for a weighing pan carrier and, optionally, a window opening for a spirit level which may be recessed in the top surface.

3. The draft shield of claim 2, wherein:
the piece of flat material comprises metal or of a synthetic material.

4. The draft shield of claim 3, wherein:
the piece of flat material comprises sheet metal.

5. The draft shield of claim 2, wherein:
the piece of flat material has the cutouts sized and arranged for fastening to, and use in association with, the top surface of a particular balance housing.

6. The draft shield of claim 5, wherein:
the box is formed from:
a rigid, box-shaped frame;
wall panels of a transparent material; and
a ceiling panel of a transparent material;
wherein the wall panels are set into, and removed from, the frame from above, and the ceiling panel is removably laid into the frame from above or slid into the frame from the side.

7. The draft shield of claim 6, wherein:
the rigid, box-shaped frame comprises:
a right frame part;
a left frame part;
a pair of upper transverse members; and
a pair of lower transverse members;
each of the frame parts formed of an integral piece of material, with the transverse members connecting the respective frame parts to each other.

8. The draft shield of claim 7, further comprising:
a storage compartment, formed at the rear wall, the storage compartment sized to receive and store at least one of the panels.

9. The draft shield of claim 8, wherein:
the wall panels and the ceiling panel are configured as five mutually identical square-shaped plates.

10. The draft shield of claim 1, wherein:
the piece of flat material has the cutouts sized and arranged for fastening to an use in association with the top surface of a particular balance housing.

11. The draft shield of claim 6, further comprising:
a storage compartment, formed at the rear wall, the storage compartment sized to receive and store at least one of the panels.

12. The draft shield of claim 6, wherein:
the wall panels and the ceiling panel are configured as five mutually identical square-shaped plates.

13. The draft shield of claim 1, wherein:
the box is formed from:
a rigid, box-shaped frame;
wall panels of a transparent material; and
a ceiling panel of a transparent material;
wherein the wall panels are set into, and removed from, the frame from above, and the ceiling panel is removably laid into the frame from above or slid into the frame from the side.

14. A kit for assembly of a draft shield for a balance having a weighing pan that is arranged above a top surface of a balance housing when the balance stands in operation upon a work surface, the balance also having a display- and operating part; the kit comprising:
a right and a left frame part, each of the frame parts formed of an integral piece of material;
a pair of upper transverse members; and
a pair of lower transverse members;
four wall panels;
one ceiling panel; and
at least one centering and bottom closure part, each centering and bottom closure part comprising a piece of flat material having an outside border contour and at least one cutout sized and arranged for fastening to, and use in association with, the top surface of a particular balance housing;
such that the respective frame parts, transverse members and panels are sized and adapted to be assembled into a box that stands independently on the work surface, leaves a clear space at least on the sides of the balance housing, and, in its installed state, encases the balance and defines a weighing compartment thereof, a front and rear wall of the box each having a bottom edge that is arranged, in operation, at a sufficient height above the work surface for the display- and operating part to protrude outside the box below the front wall and for a rear part of the balance housing to remain accessible for cable connections, and at least one of a left and a right side wall and the ceiling wall of the box designed to allow at least a portion thereof to be individually opened, the box having a an inside contour that matches the outside border contour of each of the at least one centering and bottom closure parts in the kit, so that, in operative installation, the front, rear and side walls will closely fit the outside border contour;
wherein a selected one of the at least one centering and bottom closure parts centers and secures the box in position relative to the particular balance while at the same time closing off the weighing compartment, the cutouts of the centering and bottom-closure part arranged to be seated or fastened on the top surface with a shape-conforming fit.

15. The kit of claim 14, wherein:
the at least one centering and bottom closure part comprises at least two said, centering and bottom closure parts, each having the same outside border contour but with the at least one cutout sized and arranged for fastening to, and use in association with, the top surface of different balance housings.

16. The kit of claim 14, wherein:
the frame parts, the transverse members, the wall and ceiling panels and each of the at least one centering and bottom closure parts can be laid flat atop each other in a compact package.
